(19) United States
(12) Patent Application Publication
(10) Pub. No.: US 2006/0236333 A1
(43) Pub. Date: Oct. 19, 2006

(54) Music detection device, music detection method and recording and reproducing apparatus

(75) Inventors: Yoshifumi Fujikawa, Yokohama (JP); Kazushige Hiroi, Machida (JP)

Correspondence Address: MCDERMOTT WILL & EMERY LLP, 600 13TH STREET, N.W., WASHINGTON, DC, 20005-3096, US

(73) Assignee: HITACHI, LTD.

(21) Appl. No.: 11/367,557

(22) Filed: Mar. 6, 2006

(30) Foreign Application Priority Data
Apr. 19, 2005 (JP) 2005-120483

(51) Int. Cl. H04N 7/16; H04H 9/00

(52) U.S. Cl. 725/19

(57) ABSTRACT

A method and device for detecting music parts within a content at relatively low cost of arithmetic operations. The device includes a first power calculating section for calculating a sum of powers of respective channels of two-channel sound, a second power calculating section for calculating a difference between the powers of the respective channels of the two-channel sound, a power ratio calculating section for calculating a ratio between the powers calculated by the first and second power calculating sections, a comparing section for comparing the ratio calculated by the power ratio calculating section with a prescribed threshold value, and a determination section for performing determination of a music segment based on a result of comparison by the comparing section.

### INCORPORATION BY REFERENCE

The present application claims priority from Japanese application JP 2005-120483 filed on Apr. 19, 2005, the content of which is hereby incorporated by reference into this application.

### BACKGROUND OF THE INVENTION

The present invention relates to a method for controlling reproduction of a video or audio content.

In recent years, television broadcasting receiver equipment with an integrated hard disk allowing long-time recording, and video viewing equipment allowing view of video contents distributed through a communication network have begun to spread. Hence, the amount of the video contents dealt by a viewer is rapidly increasing.

However, the amount of time a viewer can spend viewing the video contents is restricted and therefore, there is a demand for a technique that enables efficient viewing of the video contents.

In response to such a demand, techniques to help grasping of the summary of each video content in a short period of time have been developed, which include a technique for reproducing a digest of a video content, and a technique for displaying thumbnail images of scenes (clips, shots) of a video content side by side (see, e.g., JP3367268, JP-A-2004-312567).

With regard to music programs, it is desired to quickly search for music parts or talk parts. This requires detection of the music parts within the content.

A typical conventional method for detecting a music part is disclosed in JP3088838, wherein sound is divided into a plurality of frequency bands, and time series changes in the power of the respective bands are measured. The part in which the power of each band changes periodically is regarded as the music part.

### SUMMARY OF THE INVENTION

With the conventional method disclosed in JP3088838, however, such decomposition into frequency bands and calculation of periodicity would impose relatively heavy processing load and take time. This is undesirable for a user, and would also bring about an increase in the hardware cost. Therefore, an implementation method of a lighter processing load is demanded.

To solve the above problem, a technical configuration is provided, which includes a first power calculating section for calculating a sum of powers of respective channels of two-channel sound, a second power calculating section for calculating a difference between the powers of the respective channels of the two-channel sound, a power ratio calculating section for calculating a ratio between the powers calculated by the first and second power calculating sections, a comparing section for comparing the ratio calculated by the power ratio calculating section with a prescribed threshold value, and a determination section for performing determination of a music segment based on a result of comparison by the comparing section.

With this configuration, music detection can be performed at a low cost, which can realize cost reduction of an applied system.

Other objects, features and advantages of the invention will become apparent from the following description of the embodiments of the invention taken in conjunction with the accompanying drawings.

### BRIEF DESCRIPTION OF THE DRAWINGS

FIG. 1 is an overall block diagram of a device for obtaining music segments from audio data;

FIG. 2 is a block diagram of an audio feature calculation device;

FIG. 3 is a block diagram of a music segment determination device;

FIG. 4 is an overall block diagram of a device for obtaining music segments from a compressed audio stream;

FIG. 5 is a block diagram of an applied system; and

FIGS. 6A-6C show a flowchart for the applied system.

### DESCRIPTION OF THE EMBODIMENTS

Hereinafter, embodiments of the present invention will be described.

### First Embodiment

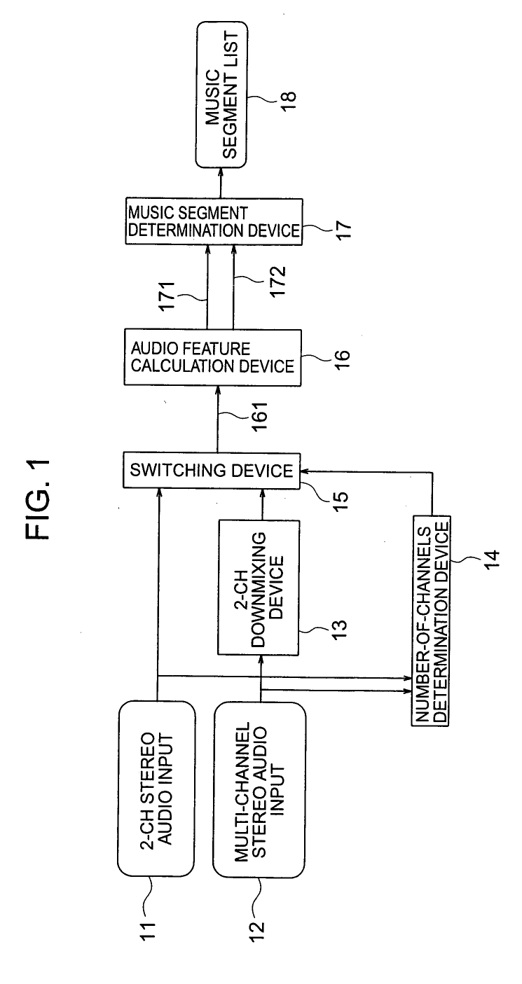

A first embodiment will be described with reference to FIGS. 1 through 3. Audio data of a given content is input as a two-channel stereo audio input 11 or a multi-channel stereo audio input 12.

The multi-channel stereo refers to 5.1-channel or 7-channel surround sound. Multi-channel stereo audio input 12 is converted by a two-channel downmixing device 13 into two-channel stereo sound. The conversion is conducted through the use of a formula for the linear combination, by which two multi-channel signals is changed to two-channel signals. An example of the formula for the linear combination is provided, e.g., in Association of Radio Industries and Businesses, “Receiver for Digital Broadcasting Standard (ARIB STD-B21 Ver. 1.2)”, pp. 23-24, “6.2.1 Decoding Process for Audio Signal”.

A number-of-channels determination device 14 determines the number of channels of the input sound based on two-channel stereo audio input 11 and multi-channel stereo audio input 12, and outputs a signal indicating whether or not it is the two-channel stereo sound. A switching device 15 inputs two-channel stereo audio input 11 and an output of two-channel downmixing device 13, and outputs either two-channel stereo audio input 11 or the output of two-channel downmixing device 13 as two-channel stereo data 161 in accordance with a signal from number-of-channels determination device 14. Specifically, switching device 15 outputs two-channel stereo audio input 11 when number-of-channels determination device 14 outputs a signal indicating that it is the two-channel stereo sound. When number-of-channels determination device 14 outputs a signal indicating that it is not the two-channel stereo sound, switching device 15 outputs the output of two-channel downmixing device 13 as two-channel stereo data 161.

An audio feature calculation device 16 inputs two-channel stereo data 161 output from switching device 15, and outputs L+R power data 171 and L−R power data 172. Details of audio feature calculation device 16 will be described later.

A music segment determination device 17 inputs L+R power data 171 and L−R power data 172, and outputs a music segment list 18. Music segment list 18 is formed of columns of sets of start and end positions of music segments. Each position may be represented by a time from the beginning of the content, or by a byte address of the content data. Details of music segment determination device 17 will be described later.

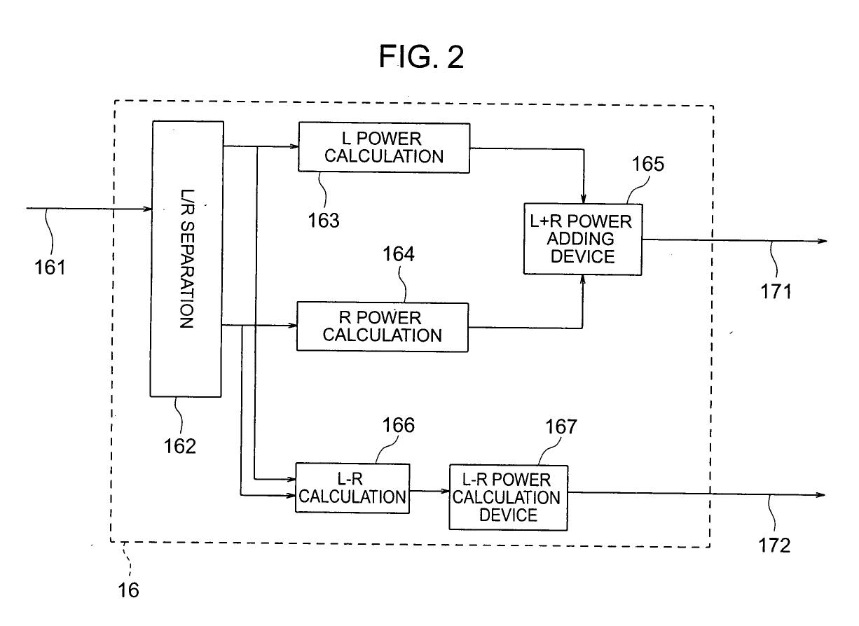

The details of audio feature calculation device 16 will now be described with reference to FIG. 2. Input two-channel stereo data 161 is separated by an L/R separation device 162 into sound of the left channel and sound of the right channel. An L power calculation device 163 calculates a variance in amplitude value of audio data of the left channel to obtain power of the left channel. Similarly, an R power calculation device 164 obtains power of the right channel from audio data of the right channel. An L+R power adding device 165 adds outputs of L power calculation device 163 and R power calculation device 164 to output L+R power data 171.

An L−R calculation device 166 outputs difference data of the amplitude values of the left and right channels to an L−R power calculation device 167. L−R power calculation device 167 calculates a variance of the difference data to obtain and output L−R power data 172.

In this manner, audio feature calculation device 16 inputs two-channel stereo data 161 output from switching device 15, and outputs L+R power data 171 and L−R power data 172.

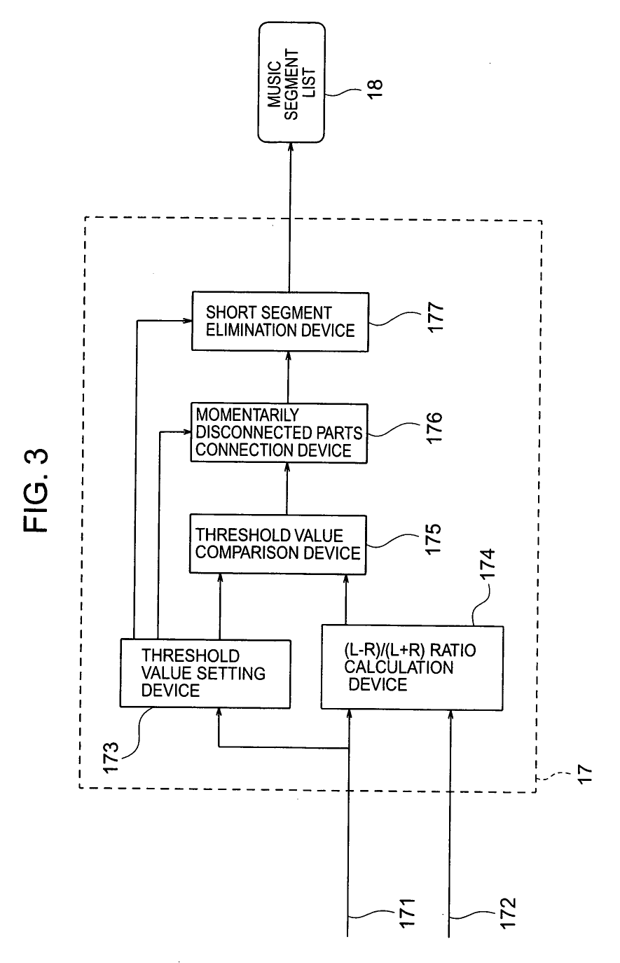

The details of music segment determination device 17 will now be described with reference to FIG. 3. A threshold value setting device 173 sets threshold values for a threshold value comparison device 175, a momentarily disconnected parts connection device 176 and a short segment elimination device 177, based on a maximum value of input L+R power data 171 and a category of the content (Western music, Japanese music, pops, classics, or the like). The threshold values may be set using numerical expressions based on the input values, or may be set using tables. The category of the content may be specified using data attached to the content, or using data of an electronic program guide, or a user may select it via a key input.

A ratio calculation device 174 calculates and outputs a ratio of L−R power data 172 to L+R power data 171. More specifically, it calculates (L−R power data 172) . (L+R power data 171). If L+R power data 171 is zero, it outputs zero. The above expression may be replaced with (L−R power data 172)÷√(L+R power data 171). The ratio is calculated for the purpose of improving a detection rate of relatively quiet music.

Threshold value comparison device 175 compares the output of ratio calculation device 174 with a threshold value set by threshold value setting device 173, and outputs segments in which the output of ratio calculation device 174 is greater than the threshold value in the form of a first music segment list.

In the first music segment list output from the threshold value comparison device 175, if a time interval of the gap between two music segments adjacent in time is shorter than a threshold value set by the threshold value setting device 173, a momentarily disconnected parts connection device 176 connects the two segments into one. For example, two adjacent music segments may be represented as (t0, t1) and (t2, t3). This indicates that one music segment starts at t0 and ends at t1, while the other music segment starts at t2 and ends at t3, where the relation t0<t1<t2<t3 holds true. At this time, if the difference between t2 and t1 (t2−t1) is not longer than the threshold value, they are combined into one music segment (t0, t3) starting at t0 and ending at t3. If (t2−t1) is longer than the threshold value, they are output as two music segments (t0, t1) and (t2, t3) without modification. The threshold value may suitably be from about 0.1 second to about 1 second. This processing is carried out for every two adjacent music segments. The momentarily disconnected parts connection device 176 outputs the resultant segments in the form of a second music segment list, which list is provided to a short segment elimination device 177.

The short segment elimination device 177 calculates a length of each music segment in the received second music segment list, and removes the segments not longer than a threshold value set by threshold value setting device 173 from the list. It maintains the segments longer than the threshold value in the list, and outputs the resultant list as a music segment list 18. The threshold value may suitably be from about 10 seconds to about 30 seconds.

With the operations described above, the music segment determination device 17 inputs L+R power data 171 and L−R power data 172, and outputs music segment list 18.

The music detection device of the first embodiment is implemented by the operations described above in conjunction with FIGS. 1-3.

### Second Embodiment

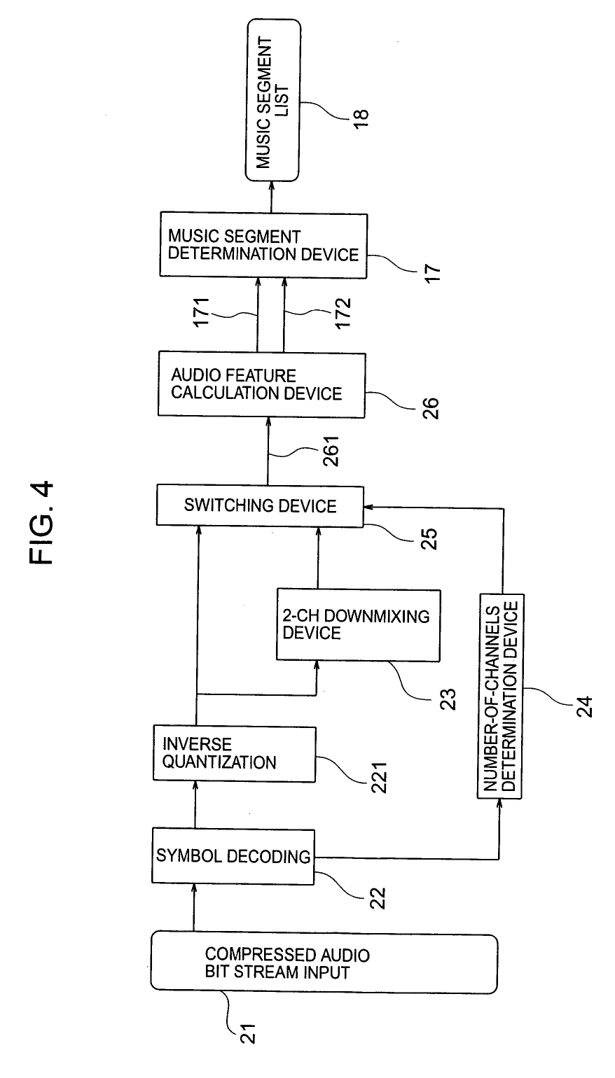

Hereinafter, a second embodiment will be described with reference to FIG. 4. Audio data of a given content is input as a compressed audio stream input 21 such as MPEG audio. Decoding of many of such compressed audio streams like the MPEG audio typically includes decoding of symbols coded by Huffman codes, arithmetic codes or the like, inverse quantization of the symbol values, and transformation from the frequency domain to the time domain.

Compressed audio stream input 21 is firstly provided to a symbol decoding device 22 for decoding of Huffman codes or arithmetic codes. The decoded symbols are dequantized by an inverse quantization device 221 to obtain frequency domain data.

A number-of-channels determination device 24 determines the number of channels from the symbols decoded by symbol decoding device 22, and outputs a signal indicating whether it is the two-channel stereo sound or not.

If it is not the two-channel stereo sound, a two-channel downmixing device 23 generates two-channel data by a linear combination of the output data of inverse quantization device 221 in a similar manner as in two-channel downmixing device 13, except that the linear combination in this case is performed on the same frequency components of the respective channels.

A switching device 25 outputs the output data of inverse quantization device 221 as dequantized coefficient data 261 when number-of-channels determination device 24 outputs a signal indicating that it is the two-channel stereo sound. If number-of-channels determination device 24 outputs a signal indicating that it is not the two-channel stereo sound, then switching device 25 outputs the output of two-channel downmixing device 23 as dequantized coefficient data 261.

An audio feature calculation device 26 outputs L+R power data 171 and L−R power data 172 in a similar manner as in audio feature calculation device 16 of the first embodiment. The details of audio feature calculation device 26 are similar to those of audio feature calculation device 16 of the first embodiment. In the present embodiment, however, the difference between the left and right channels is obtained by calculating a difference between the same frequency components. To obtain the power, a sum of squares of each frequency component is calculated instead of the variance of amplitude. Music segment determination device 17 is identical to that of the first embodiment. In this manner, the music detection device of the second embodiment is implemented.

### Third Embodiment

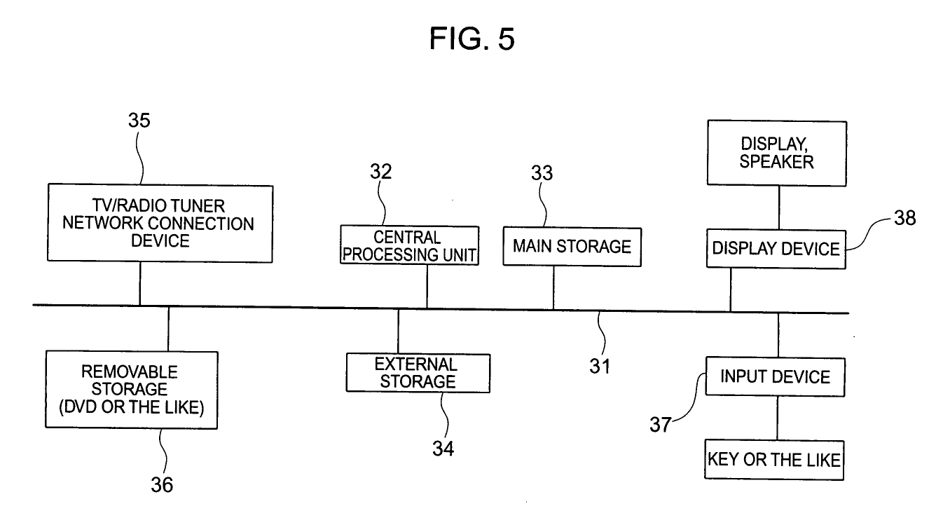

In the third embodiment, the method of the first or second embodiment is implemented in an electronic computer system shown in FIG. 5. The system includes a system bus 31, a central processing unit 32, a main storage 33, an external storage 34, a tuner/network connection device 35, a removable storage 36, a display device 38, and an input device 37.

External storage 34 stores programs for controlling operations of the entire system, content data, music segment data, various intermediate data and others. The programs in external storage 34 are read to main storage 33. Central processing unit 32 sequentially reads the programs from main storage 33 and performs processing operations according to the programs.

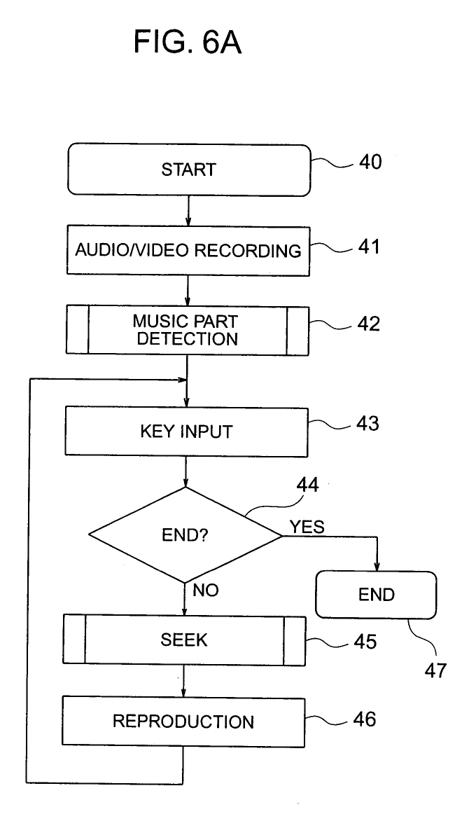

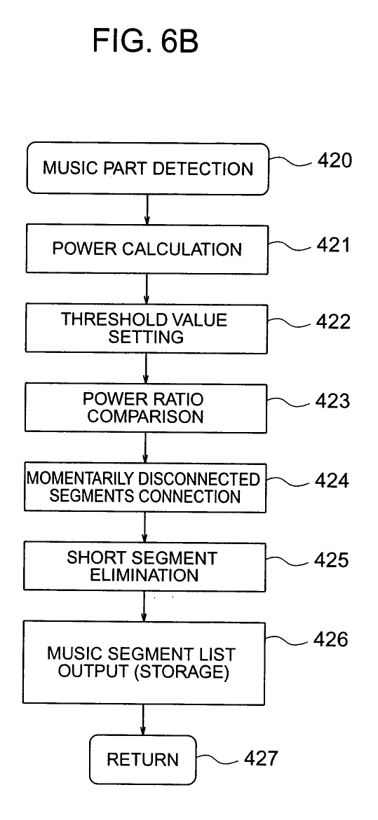

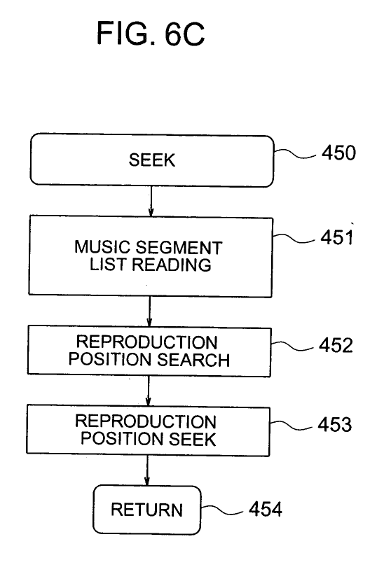

FIGS. 6A-6C show a flowchart of a program on the electronic computer system shown in FIG. 5. The program starts at 40 and ends at 47 in FIG. 6A.

Starting at start 40 in FIG. 6A, initially, in audio/video recording 41, a content is received via the tuner/network connection device 35, and is recorded on external storage 34 or removable storage 36. The tuner/network connection device 35 receives radio or television broadcasting, or contents distributed through a network. Removable storage 36 is formed, e.g., of DVD, CD, magnetic tape, magnetic disk, semiconductor memory or the like.

Next, in music part detection 42, a series of operations from start of music part detection 420 to return 427 shown in FIG. 6B are carried out to obtain and store a music segment list in external storage 34 or removable storage 36. In key input 43, an input is received from input device 37 via a key of a remote controller or an operation key on the device. In determination about end 44, it is determined whether an end key has been depressed. When the end key is depressed, the process is terminated at end 47.

In the absence of depression of the end key, the process proceeds to seek processing 45, where a series of operations from start of seek 450 to return 454 shown in FIG. 6C are carried out to move a reproduction position to a position to be reproduced next in the content. Reproduction 46 is then carried out, and the process returns to key input 43.

Hereinafter, music part detection 42 will be described in detail. In FIG. 6B, firstly, in power calculation 421, L+R power data and L−R power data are calculated. They may be calculated from amplitudes by decoding the audio data, as in the first embodiment, or may be calculated directly from the frequency data within the compressed stream, as in the second embodiment.

In threshold value setting 422, various threshold values are set based on the L+R power data and the category information of the content, in a similar manner as in threshold value setting device 173 of the first embodiment. In power ratio comparison 423, the ratio is calculated in a similar manner as in ratio calculation device 174 of the first embodiment, and is compared with a threshold value in a similar manner as in threshold value comparison device 175 of the first embodiment, to thereby obtain a first music segment list.

In momentarily disconnected segments connection 424, in the case where a gap between the adjacent music segments in the first music segment list is not longer than a threshold value, the relevant music segments are combined, in a similar manner as in momentarily disconnected parts connection device 176 of the first embodiment, to generate a second music segment list. In short segment elimination 425, in a similar manner as in short segment elimination device 177 of the first embodiment, a length of each music segment in the second music segment list is obtained and the music segment not longer than a threshold value is removed from the music segment list, to thereby generate a third music segment list.

In music segment list output 426, the third music segment list obtained by short segment elimination 425 is stored as a music part detection result in external storage 34 or removable storage 36.

Hereinafter, seek processing 45 will be described in detail. In FIG. 6C, firstly, in music segment list reading 451, the music segment list stored on music segment list output 426 is read from external storage 34 or removable storage 36. Next, in reproduction position search 452, a position to be reproduced next is searched for based on the current reproduction position and a key input. For example, when a key for jumping to the beginning of the next song is depressed, the music segment of which start position is the smallest in time among those having the start positions greater in time than the current reproduction position is retrieved, and the start position of the relevant segment is obtained. When a key for jumping to the beginning of the preceding song is depressed, the music segment of which end position is the greatest in time among those having the end positions smaller in time than the current reproduction position is retrieved, and the start position of the relevant segment is obtained.

In reproduction position seek 453, the reproduction position is moved to the position obtained by reproduction position search 452. Seek processing 45 is terminated by return 454.

The third embodiment described above can implement an audio and video recording and reproducing apparatus having a song cueing function.

Although several embodiments of the invention have been described, it will be understood that the invention may be carried out with many modifications without departing from the essence of the invention. Further, the above embodiments include various configurations, which may be extracted by combining the disclosed constituent elements as appropriate. For example, even if some of the constituent elements of the embodiment are removed in a configuration, it will be appreciated that the configuration is within the scope of the invention when it can solve the above-described problem to be solved by the invention and enjoy the above-described effect of the invention.

Claims:

1. A music detection device, comprising:
a first power calculating section which calculates a sum of powers of respective channels of two-channel sound;
a second power calculating section which calculates a difference between the powers of the respective channels of the two-channel sound;
a power ratio calculating section which calculates a ratio between the powers calculated by said first and second power calculating sections;
a comparing section which compares said ratio calculated by said power ratio calculating section with a prescribed threshold value; and
a determination section which performs determination of a music segment based on a result of comparison by said comparing section.

2. The music detection device according to claim 1, wherein when said ratio calculated by said power ratio calculating section is greater than the prescribed threshold value, said determination section determines that a part associated with the comparison is a music segment.

3. The music detection device according to claim 1, wherein when a gap between two adjacent music segments is shorter than a threshold value, said determination section determines that the two music segments are continuous.

4. The music detection device according to claim 1, wherein when a detected segment is shorter than a threshold value, said determination section determines that the segment is not a music segment.

5. The music detection device according to claim 1, comprising:
a converting section which downmixes and converting multi-channel stereo sound to two-channel sound; and
a detecting section which detects a music segment based on the downmixed two-channel sound.

6. The music detection device according to claim 1, comprising:
a decoding section which decodes symbols in a compressed audio bit stream;
a frequency component calculating section which calculates frequency components by dequantizing said decoded symbols;
a power difference calculating section which calculates a power of a difference between two channels by a sum of squares of a difference between said frequency components of the two channels for each frequency; and
a calculating section which calculates a sum of powers by a sum of squares of said frequency components for each frequency.

7. An audio recording and reproducing apparatus, comprising:
the music detection device as recited in claim 1;
a section which stores a music segment list obtained by said music detection device;
a section which searches for a position at the beginning of a song in response to manipulation of a song cueing key for use in song cueing; and
a section which moves a reproduction position. to the position at the beginning of the song obtained by said search.

8. A music detection device, comprising:
a first power calculating section which calculates a sum of powers of respective channels of two-channel sound;
a second power calculating section which calculates a difference between the powers of the respective channels of the two-channel sound;
a power ratio calculating section which calculates a ratio between the powers calculated by said first and second power calculating sections;
a first determination section which determines a part in which the ratio obtained by said power ratio calculating section is not smaller than a prescribed threshold value to be a first music part;
a second determination section which obtains a second music part by connecting two of said first music parts that are momentarily disconnected from each other; and
a third determination section which removes any of said second music parts shorter than a prescribed length, and for determining any of said second music parts not shorter than the prescribed length to be a third music part.

9. A music detection method, comprising:
a first power calculating step of calculating a sum of powers of respective channels of two-channel sound;
a second power calculating step of calculating a difference between the powers of the respective channels of the two-channel sound;
a power ratio calculating step of calculating a ratio between the powers calculated in said first and second power calculating steps;
a comparing step of comparing said ratio calculated in said power ratio calculating step with a prescribed threshold value; and
a determination step of performing determination of a music segment based on a result of comparison in said comparing step.
